(19) United States
(12) Patent Application Publication
(10) Pub. No.: US 2005/0278378 A1
(43) Pub. Date: Dec. 15, 2005

(54) Systems and methods of geographical text indexing

(75) Inventor: John R. Frank, Cambridge, MA (US)

Correspondence Address: WILMER CUTLER PICKERING HALE AND DORR LLP, 60 STATE STREET, BOSTON, MA, 02109, US

(73) Assignee: MetaCarta, Inc., Cambridge, MA (US)

(21) Appl. No.: 11/133,138

(22) Filed: May 19, 2005

Related U.S. Application Data
(60) Provisional application No. 60/572,558, filed on May 19, 2004.

(51) Int. Cl. G06F 7/00

(52) U.S. Cl. 707/104.1

(57) ABSTRACT

A method of processing a document, the method involving: identifying a plurality of one or more geospatial references within the document; and for each identified geospatial reference of the plurality of geospatial references: (1) associating a geographical location with the identified geospatial reference, the geographical location being represented by a set of coordinates of a selected coordinate system; (2) generating a geographical text string that encodes the geographical location, wherein generating involves the geographical text string may involve interleaving the coordinates to form a hierarchical representation; and (3) associating the geographic text string with the identified geospatial reference.

This application claims the benefit of U.S. Provisional Application No. 60/572,558, filed May 19, 2004, and incorporated herein by reference.

### TECHNICAL FIELD

This invention relates to document databases, geographical information retrieval, and search engines.

### BACKGROUND

There are many text search tools that enable searchers to comb through documents and locate explicitly specified text. Text search engines are among a widely used family of tools that enable users to search documents for specific words, called keywords, and for key phrases. Text search engines also typically support queries that include range constraints, phrase queries, wildcard queries, and Boolean combinations of any permissible query.

It is sometimes desirable to search documents with a geospatial query. In a geospatial query, a searcher looks for information that corresponds to a range of spatial geographical locations. Such a range is specified as a range of geographical coordinates, such as a latitude and longitude range. To perform a geospatial query, a searcher must use a special search engine that employs specially constructed spatial indices, such as R-trees or quad-trees, which index data records according to geographic fields in the records. To construct a system that would allow users to search documents using both keyword constraints and geographic constraints, one might use two separate indices: one textual and one spatial. Such a system must re-sort the results after intersecting the separate result lists from the two indices. Such a sorted join is typically quite inefficient, requiring many disk seeks for a large collection of documents, and could take minutes or even hours to answer simple queries on large collections of documents. Combining two separate indices cannot deal efficiently with queries that combine geospatial queries with text search.

### SUMMARY

Embodiments described herein employ a variety of methods for geographic text searching that use traditional text search indices without creating separate geographic indices. These techniques allow a generic keyword search system to limit results to specific geographic domains without special indexing for geographic coordinate and natural language confidence score metadata. Further, these techniques allow the unmodified generic keyword search system to sort the results of such multiply-constrained queries according to relevance factors with at least some knowledge of the multiple constraints. Other embodiments described herein describe modifications that can be made to generic keyword search systems to enable their relevance sorting functions to have more awareness of the geographic information in the documents. Such a modified search system is referred to herein as an “enhanced search engine.”

Thus, embodiments described herein address two specific challenges in constructing geographic search systems: 1) efficiently generating lists of documents that match searches comprising both geographic and non-geographic search constraints, and 2) efficiently sorting such lists based on relevance functions that incorporate both geographic and non-geographic assessments of the pertinence of each document to the specified search. This is achieved by encoding geographic coordinates, confidence scores, emphasis scores, and other information in specially formatted strings. The described embodiment teaches several methods of formatting these strings such that they can be accessed using generic text search commands.

This allows a geographic-map-based user interfaces to access unstructured documents from generic keyword search systems without requiring separate geographic range query indices, which require expensive sorted joining to answer user queries with properly sorted results. If the geographic and non-geographic queries are answered by separate indices, then lists of results from the two indices must not only be intersected together but also re-sorted according to a new sorting function that incorporates both geographic and non-geographic factors. An example of a relevance function that incorporates both geographic and non-geographic factors is a textual proximity relevance function, which detects when geographic references that match a search query are textually close to non-geographic terms specified by the search query. For example, a document with a sentence that matches both geographic and non-geographic query constraints is clearly more relevant than a document that matches the constraints via paragraphs at opposite ends of the document. This and other combined relevance functions require whole document analysis, which is extremely expensive to perform at the time of joining results from separate indices. This re-sorted intersection, also known as a sorted join, takes time proportional to the size of the two lists being joined, which is typically the size of the collection of documents. For collections of millions of documents, this could mean minutes, hours, or even days to compute search results.

Described herein are a variety of methods of representing geographic location metadata about documents in textual strings that can be indexed as though they were regular keywords and can be searched for using a variety common keyword search techniques, including trailing wildcard queries, phrase queries, and Boolean operator queries. Certain embodiments employ graphical user interface techniques for utilizing this geographic information. In general, the system of the geographic mapping user interface interacts with one or several text search indices containing such specially encoded geographic metadata. These techniques described herein allow geographic metadata to be added to existing text search infrastructure possibly without any modification of the existing text search indexing software. Specific modifications useful to further improving performance are also disclosed.

In other prior art systems, coordinate metadata is typically stored in an index. For example, systems such as those described in U.S. patent applications Ser. No.09/791,533 and No. 10/633,915, also owned by the assignee of the present application and incorporated herein by reference, use a special index for holding textual information from documents in a highly unique structure that permits geographic range searches to be combined with text searches. These prior art systems achieve the goal of efficiently computing sorted joins by holding both textual and geographic data in an unusual data structure. This specialized index data structure, known as CartaTrees, arranges all the words from the documents into spatial trees that resemble traditional geographic quad-trees. Since generic search engine tools, such as Verity's K2, Autonomy's IDOL, and Apache's Lucene, do not contain such hybrid spatio-textual indices, they cannot answer geographic searches without merging and resorting results from two separate indices. The concepts described herein enable a specialized client application (called the “enhanced map user interface”) to utilize a generic search index for geographic searches. The concepts described herein move the complexity of geographic search out of the index and into client software that utilizes specialized metadata stored using generic techniques in the generic index.

Traditional text indexing software, text indexes, and text search engine software have no mechanisms for handling spatial domain queries, also known as geographic range queries. Many text indices have facilities for applying comparison operators denoted by <>≦≧ to metadata indexed along with the documents from a repository, but this metadata must be loaded separately into separate indices capable of applying Euclidean metrics for comparing data values. Typically text indices, treat words as discrete data elements without any notion of a “distance” between two words in the abstract. While typical text search indices do capture the so-called “character distance” between words in each specific document, this is not a grounded distance metric on the space of words themselves. Geographic distances on the Earth provide exactly such a grounded distance metric: the distance between any two points can be measured in kilometers, independent of any documents mentioning these points. Thus, for generic text search systems to hold geographic information, they must use multi-dimensional range query indices, such as R-trees or quad-trees or other special spatial data indexes that are separate from their text indices. This separation forces such systems to typically take a long time to answer queries that combine these operators with other text search commands. Generating relevance-sorted result lists based on geographic ranges is either impossible or extremely slow in traditional text search engines.

Various of the embodiments described herein feature methods of using traditional text search indices to store and access coordinate and also, optionally, confidence metadata and other relevance factors generated by a geoparser. A geoparser is a software system that creates geographic coordinates based on information about electronic files. A geoparser might use human input to decide what coordinates to associate with a file, or it might operate fully automatically to generate geographic coordinates to describe points, lines, polygons, and other geographic entities relevant to the file. In creating such metadata, either with the aid of a human operator or fully automatically, a geoparser typically generates confidence scores, which are numbers indicating the likelihood that a particular coordinate or geographic entity is actually correctly associated with the file. For example, a fully automatic geoparser might interpret the natural language context of the document to guess which locations the author intended. The quality of these guesses is estimated by the confidence scores (geoconfidence) output by the geoparser along with the coordinates describing the geographic entities. Geoconfidence typically figures into relevance scoring of files in response to queries that include geographic constraints. Thus, by encoding geoconfidence in a manner that allows it to be stored with geographic coordinates in a generic text search engine, these methods allow a traditional text search engine to answer some forms of relevance-sorted geographic range queries without using comparison operators and without using any special metadata tables and without necessarily requiring special loading techniques separate from those used to process all the other words in the documents.

The encodings described herein can be used in almost any text search engine without special modification to the text search engine and without need for separate geographic data structures. Useful modifications to a generic search system are possible. The invention contemplates a variety of specific enhancements to a generic search system, which make it more capable of computing good relevance functions on documents containing the specially formatted geographic strings. For example, generic search engines typically assign word positions to every word in a document and would normally assign word positions to every geographic string added to a document. By modifying a generic search engine to accept standoff metadata (described below), one can make an enhanced search engine that more appropriately handles the geographic strings. For another example, generic search engines typically have no notion of confidence scores. The invention teaches two methods of coping with this. As mentioned above, the first is to encode the geoconfidence in the specially formatted geographic string. The second method is to enhance the search engine to treat confidence as a property of all words in the documents.

By making the geographic terms accessible in keyword-searchable formats, the present invention allows further modifications, such as standoff notation and confidence scores, to operate on the same generic text index structure that holds all the other words. Thus, the present invention is a key enabler for a wide variety of additional geographic search enhancements to generic text search systems.

A key concept is that of a hierarchical coordinate system. A hierarchical coordinate system is a graph representation of a manifold, or region of an affine space. An affine space, as traditionally defined in mathematics, is a space in which any two points can be connected by a vector. There is not necessarily a preferred origin for the coordinates in an affine space, and the coordinates need not be flat (i.e. Euclidean). For example, unprojected latitude/longitude coordinates on the surface of the Earth are an example of coordinates in non-Euclidean affine space. Each point in the affine space can be defined by an n-tuple of numbers. In general such numbers could be real or complex; latitude/longitude on the Earth uses real numbers. Especially in geographic information systems (GIS), such coordinate n-tuples are often assumed to be of infinite precision, which means that a infinite string of zeros is implicitly assumed to exist at the end of each number in the n-tuple. That is, the coordinates:

(48.23, 22.39)

are actually:

(48.2300000000 . . . , 22.39000000 . . . )

where the zeros repeat forever. This means that coordinate tuples define point objects.

In contrast, hierarchical coordinate systems define objects with extent. A hierarchical coordinate system can refer to very small areas using a long string. However, to describe an actual point, a hierarchical string would have to be infinitely long. This area property of hierarchical strings is integral to the methods disclosed here. For example, a polygon on the surface of the Earth has area, and a set of polygons inscribed inside that polygon also have areal extent. For example, the country of Germany can be described by a polygon with areal extent. The various provinces inside of Germany can be described by polygons that also have areal extent. A hierarchical coordinate system is constructed by assigning names to each of these polygons and including in each name all the names of its enclosing polygons. The enclosing polygons are parents of the child polygons in a tree structure. A hierarchical coordinate system is simply a naming convention on such a tree structure, or directed acyclic graph. The hierarchical coordinate system allows the name of each polygon to unambiguously identify all of the parent nodes above it in the tree. The Military Grid Reference System (MGRS) and the Quaternary Triangular Mesh (QTM) are examples of hierarchical coordinate systems. In QTM, the earth is covered by a mesh of triangles, and each triangle is subdivided into four new “child” triangles. To initialize the QTM tree structure, eight large triangles are placed on the Earth in the shape of an octahedron (See http://www.spatial-effects.com/SE-papersl.html for background on QTM.) These initial eight triangles can be numbered 0 through 7. These triangles are then subdivided into smaller triangles. By numbering each triangle with a number (0, 1, 2, or 3), any triangle can be identified by a string that lists first the largest enclosing triangle, and then the next smaller enclosing triangle, and then the next smaller, and so on until the number of the smallest triangle is listed.

For example, a triangle covering part of Germany might be the 2nd triangle within the 3rd triangle of the 5th large triangle used to initialize the tree structure. This triangle over Germany would be identified by the string 532. This triangle contains four triangles at the next level down in the hierarchy, which have the names 5320, 5321, 5322, and 5323. Each of these also contains four triangles, and so on to any level of depth. Deeper levels correspond to higher spatial precision.

Another defining feature of hierarchical coordinate strings is that symbols on opposite ends of the string refer to large and small scales. Each additional symbol in the string corresponds to progressively smaller scale. As with any decimal-like system, the symbols could be written right-to-left or left-to-right with obviously appropriate changes to the generic query styles. Any string of symbols designating progressively smaller areas (or hypervolumes) of an affine space can be used as a hierarchical coordinate.

Such a hierarchical coordinate system can be constructed from any affine vector. The n-tuple of numbers defining a point in an affine space can be reformatted in the spirit of a hierarchical coordinate system using methods described below. The invention teaches a method of converting any affine space vector n-tuple into a useful hierarchical representation.

The invention utilizes such hierarchical tree representations of affine spaces to construct word-like strings that contain higher-than-one-dimensional meaning, such as for example, geographic meaning. These word-like strings can be constructed for any data object with spatial coordinates. Regardless of whether the original spatial coordinates were formatted as affine vectors that had to be converted or were already formatted as hierarchical tree coordinates, the invention teaches a number of methods for formatting the hierarchical strings for use in a generic text search engine. These formatting techniques allow generic text search commands to operate on the specially encoded strings such that they can detect the geographic meaning of the string without requiring the generic text search engine to have any notion of geography. The described embodiment uses hierarchical coordinate systems in two ways: first, to access hierarchical string encodings via generic text search commands used in a text index designed for holding only words; and second, to allow the specially formatted hierarchical strings to impact the relevance scoring that sorts the results produced in response to queries.

As referred to herein, a “query style” is any type of search command that might be issued to a search engine. For example, the wildcard query style allows the user to find documents containing words that include a substring specified by the wildcard query. The commonly known syntax for regular expressions applies here. For example, searching for:

te?t

finds all strings that begin with “te” and end in “t” with one letter in between. And searching for:

te*t

finds all strings that begin with “te” and end in “t” with any number of letters in between. A particular query style used in some embodiments is the trailing wildcard query style, which puts an asterisk at the end of the query string, as follows:

te*

which retrieves all documents containing words that begin with the letters “te” and have any number of letters afterwards, including no letters.

Another type of query style is the phrase query style. A phrase search is typically designated by putting quotation marks around the query words, as follows:

“elephant food”

which finds only those documents containing the words “elephant” and “food” next to each other. Without the quotation marks, a typical search engine would return all documents containing both words in any position. Some search engines support a nearness operator that can act on phrase searches like this:

“elephant food”−30

This finds all documents containing the words within 30 words of each other. This requires the engine to break the document into words, usually based on analyzing the punctuation of the document to identify word boundaries.

Another query style is a Boolean query style, which allows the user to combine various other query styles into single expressions using the commonly known AND OR and NOT operators.

Many query styles exist. As used herein, “generic query styles” refer to those query styles that operate on strings without interpreting any meaning in the strings. An example of a non-generic query style is a standard range query, which attributes relational meaning to the data in the fields against which the query operates. The commonly known greater-than and less-than operators can only be applied to data objects that have been cast into a meaningful form. Typically this meaning creation is achieved by putting the data objects in a typed field, where the type is isomorphic to the integers. Since the greater-than and less-than operators can be defined on the integers, one can use the isomorphism between the typed field and the integers to apply the range operators. This meaning creation step is not required for generic query styles, which can operate on untyped strings of symbols alone. Such untyped strings are often referred to as unstructured data. Generic query styles operate on unstructured data.

The described embodiment constructs a geographic search system using only generic query styles. That is, it builds a geographic search system utilizing an index designed only to handle unstructured data. Even if an engine supports a variety of non-generic query styles, they are likely to perform slowly when combined with word searches on large collections of documents (as discussed above).

In addition to using these generic query styles to access these specially formatted hierarchical string encodings, the described embodiment further discloses an enhanced search engine that can efficiently compute some forms of geographically aware relevance for sorting the results. Of the many factors that could go into such a geographically aware text search relevance function, three factors of high importance are described. The described embodiment teaches how to capture these three factors when using specially formatted hierarchical string encodings via generic query styles on both generic search engines and enhanced search engines.

Further, the described embodiment uses these specially formatted hierarchical string encodings to allow an enhanced map search interface to access multiple document repositories via text search engines that support different types of generic query styles. Such an enhanced map search interface can perform so-called federated search across multiple repositories and efficiently merge the results together into one or more result sets.

In general, in one aspect, the invention features a method of processing a document. The method involves: identifying a plurality of one or more geospatial references within the document; and for each identified geospatial reference of the plurality of geospatial references: (1) associating a geographical location with the identified geospatial reference, the geographic location being represented by a set of coordinates of a selected coordinate system; (2) generating a geographic text string that encodes the geographic coordinates, wherein generating a geographic text string involves interleaving the coordinates of the set of coordinates or otherwise acquiring a hierarchical representation of the coordinates; (3) formatting the geographic text string for use with a selected query style; and (4) associating the geographic text string with the identified geospatial reference.

Other embodiments include one or more of the following features. The selected coordinate system is a non-hierarchical coordinate system on the globe or a portion of the globe (e.g. comprising latitude and longitude coordinates or, for another example, comprising Massachusetts State Plan Coordinates). Alternatively, the selected coordinate system is a hierarchical coordinate system (e.g. comprising a mesh of nested shapes, such as a triangular mesh.) A specific example of a hierarchical coordinate system is the quarternary triangular mesh coordinate system. Associating the geographic text string with the identified geospatial reference involves inserting that geographic text string into the document at the location of the corresponding geospatial reference. Alternatively, associating the geographic text string with the identified geospatial reference involves placing that geographic text string into a separate file, which also identifies the geospatial reference with which that geographical text string is associated in the document. For each identified geospatial reference of the plurality of geospatial references also determining a confidence level for the associated geographical location and wherein encoding the geographical location as a geographic text string involves encoding both the geographical location and the confidence level into the geographic text string. Generating the geographic text string involves representing the confidence level within the text string as a corresponding bin of a plurality of bins, each of said plurality of bins representing a different range of confidence levels. Generating the geographic text string involves adding a sequence of characters that identify a portion of text in the vicinity of the geospatial reference.

In general, in another aspect, the invention features another method of processing a document. The method involves: identifying a plurality of one or more geospatial references within the document; and for each identified geospatial reference of the plurality of geospatial references: (1) associating a geographical location with that identified geospatial reference, the geographical location being represented by a set of coordinates of a selected coordinate system; (2) determining a confidence level for that associated geographical location; (3) encoding both the geographical location and the confidence level for that identified geospatial reference as a geographic text string; and (4) associating the geographic text string with the identified geospatial reference.

Other embodiments include one or more of the following features. Encoding involves interleaving the coordinates of the set of coordinates for that associated geographical location to generate the geographic text string. Encoding both the geographical location and the confidence level for that identified geospatial reference as a geographic text string involves representing the confidence level within the text string as a corresponding bin of a plurality of bins, wherein each of the plurality of bins represents a different range of confidence levels. Alternatively, encoding both the geographical location and the confidence level for that identified geospatial reference as a geographic text string involves representing the confidence level as a number string and interleaving the number string along with the coordinates of the set of coordinates for that associated geographical location to generate the geographic text string. The selected coordinate system is a affine coordinate system (e.g. employing latitude and longitude coordinates). Alternatively, the selected coordinate system is a hierarchical coordinate system. Associating the geographic text string with the identified geospatial reference involves inserting that geographic text string into the document at the location of the corresponding geospatial reference. Associating the geographic text string with the identified geospatial reference involves placing that geographic text string into a separate file, which also identifies the geospatial reference with which that geographical text string is associated in the document.

In general, in still another aspect, the invention features a method of processing a set of documents. The method involves: for each document in the set of documents, identifying a plurality of one or more geospatial references within that document; and for each identified geospatial reference of the plurality of geospatial references within that document: (1) associating a geographical location with the identified geospatial reference, the geographical location being represented by a set of coordinates of a selected coordinate system; (2) determining a confidence level for the associated geographical location; encoding the geographical location and its confidence level into a geographic text string; and associating the geographic text string with the identified geospatial reference.

In still yet another aspect, the invention features a method of constructing a text search query for identifying among a plurality of documents those documents that contain geospatial references that are associated with a geographic location. The method involves: receiving an identification of the geographical location; in response to receiving that specification, representing said geographical location as a set of coordinates; and generating a geographical text string from the set of geographical coordinates by interleaving the coordinates of the set of coordinates for that geographical location.

Other embodiments include one or more of the following features. The method also includes submitting the geographical text string to a text search engine, which searches a text index to for the plurality documents to identify those documents that contain geospatial references that are associated with said geographic location. The method further includes receiving a specification of a confidence, wherein generating the geographical text string further involves combining a representation of the confidence level with the set of geographical coordinates to generate the geographic text string.

Another embodiment includes a client application that constructs text search queries for multiple text search engines using the special text strings described herein. The text encodings and query formats for the different text search engines may vary. The client application can combine the results from these various engines into one or more result sets and display them to a user in a text read out or on a geographic map.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a high level block diagram showing the principal elements of the geographical location text indexing and searching system.

FIG. 2 is a flow diagram illustrating the process for generating a text index that can be used to submit geospatial queries to a document repository.

FIG. 3 is a flow diagram illustrating the process for conducting geospatial queries of a document repository.

FIGS. 4A and 4B are diagrams illustrating the decomposition of a query from a mapping application into multiple queries.

### DETAILED DESCRIPTION

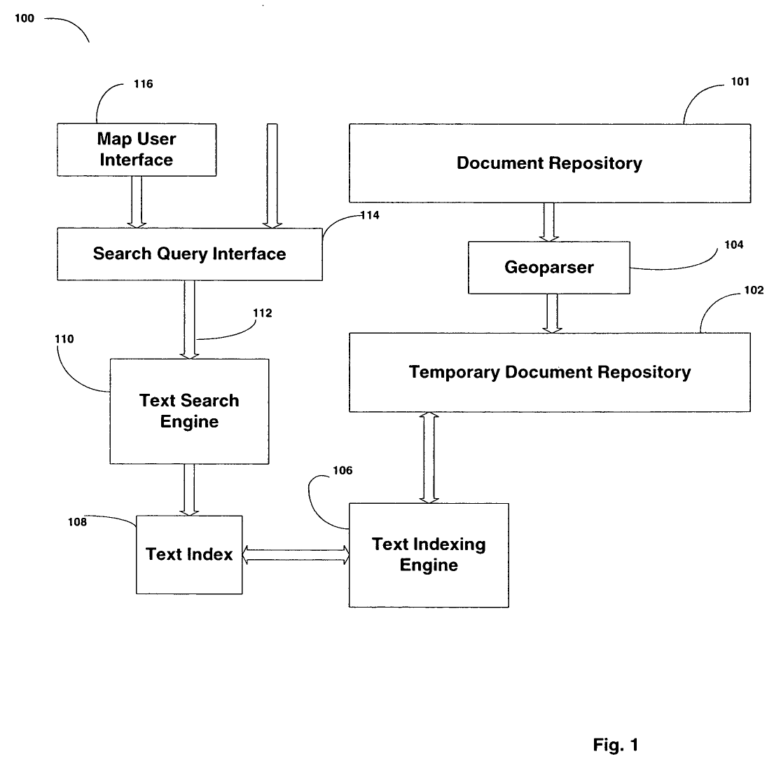

A text indexing and search system 100 that processes documents so their geospatial relevance can be searched by using a text search engine is shown in FIG. 1. System 100 includes: a document repository 101, which contains all of the documents within the search space for the system; a geoparser 104, which identifies and tags the geospatial references within the documents stored in repository 101 with a special text string and places the tagged documents into temporary document repository 102; text indexing software 106, which generates a text index 108 for all documents stored in temporary document repository 102; and text search software 110, which operates on text index 108 to find all documents in document repository 101 that are responsive to a search query 112 specified by a user. System 100 also includes a keyword search user interface 114 and a map user interface 116. Keyword search user interface 114 enables the user to specify whatever keywords are to be included within the search query; and map user interface 116 enables the user to specify whatever geospatial ranges are to be used in the search query and to also specify confidence thresholds that limit the results to only those geospatial references that meet the corresponding specified confidence thresholds. In response to receiving text strings from the user interface which specify the search query, text search engine 110 uses text index 108 to find all relevant documents and returns the results to the user, typically in the form of a visual output on a display device or as printed output or as a saved electronic file

Geoparser 104 processes each text document found in document repository 101 and for each document produces geographic coordinates, such as (latitude, longitude, altitude) for the corresponding the geospatial references that are found within that document. The function that is performed by geoparser 104 is referred to as geoparsing. Generally, geoparsing involves looking for references within a document that have geographical significance or meaning (i.e., geospatial references). For example, geoparser 104 might look for names of cities (e.g. Paris, Boston, New York); names of locations, such as Walden Pond or the Charles River; and other known strings, such as “20 miles north of Kandahar.” It interprets those references as having geospatial significance and then augments them with the coordinates of the geographical location or locations with which they might be associated.

In the described embodiment, geoparser 104 is implemented in code, which performs the geoparsing functions automatically, as described in U.S. patent application Ser. Nos. 09/791,533 and 10/633,915. However, a human can also perform the functions of a geoparser and enter the relevant information about the document by hand.

Geoparser 104 also generates a confidence score that indicates the probability that the identified textual reference actually refers to the location that geoparser 104 associates with the reference. Stated differently, it can also be viewed as the probability that the author of the document would agree with the software's choice of coordinates for that reference. These coordinates and confidence scores are data about the data in the document (namely the geospatial references within the document), so they are called “metadata.” Confidence scores are typically represented as percentages that indicate the probability that a human would agree with the location chosen by the software to represent the author's original wording. A confidence score of 68% could be interpreted to mean that sixty-eight out of a hundred human readers would agree that these coordinates are what the author intended. A particular geographic reference might be tagged with several candidate locations of varying confidence. For example, there are at least 44 cities in the world known as Paris, so a particular reference to the word “Paris” might not clearly identify which particular location was intended by the author. In such a case, an automatic geoparser might tag this reference with the coordinates for the Paris in central France at 95% confidence and the Paris in the state of Texas at 57% confidence, and other locations with other confidence scores.

The purpose of such confidence scores is to allow the system to present the most correct and most useful results first, so a human reader can understand and cope with search results from large collections of documents. Such search results are plotted on a map search user interface (which in the described embodiment is functionality that is implemented by search engine 110). By sorting the results according to confidence score, those locations that are most likely to have been tagged correctly are presented to the user first.

Geoparser 104 represents the location and confidence information (i.e., the metadata) as a specially structured text string that encodes the coordinate and confidence metadata in a way that it can be searched by using traditional text search indexing software. These special encodings take advantage of either phrase search or wildcard queries or Boolean operators to represent range queries.

In general, the encoding method that is employed by geoparser 104 converts the multiple spatial coordinates identifying a particular location into a single geographic text string. It does this by interleaving the digits that make up the coordinates of the location. So, for example, if the coordinates are (48.28°, 24.55°), which specify a position in terms of a (latitude, longitude), then one constructs the special text string by alternately taking a digit from each coordinate starting with the leftmost digit (i.e., the most significant digit) and adding it to the text string until all of the digits have been used. In the case of the coordinates (48.28°, 24.55°) this process produces the following string: “42842585.”

This interleaving technique can be applied to any multi-dimensional spatial coordinate system in which displacement along each coordinate dimension is represented by a string (typically a string of numerical digits) and each element of the string (or each digit) represents a larger spatial range than the element (or digit) to its right. In the case of the latitude coordinate used above, the “4” digit represents a range that extends between 40.00° and 49.99°. Whereas, the next digit, namely, “8” represents a range that extends between 8.00° and 8.99°, which is ten times smaller.

Other examples of coordinate systems include the Universal Transverse Mercatur (UTM). As described above, each coordinate pair is usually assumed to have infinite precision, with an infinitely long string of zeros implicitly tacked on to the end. When interleaving these coordinates, it is helpful to pad them on the left and right with enough zeros to make all coordinate dimensions the same length regardless of the actual number of significant digits and regardless of the precision.

Hierarchical coordinate systems, such as the military grid reference system (MGRS) and the quaternary triangular mesh (QTM), are already in a single-string format. The interleaving procedure described above for affine space coordinates is a method for generating hierarchical coordinates that correspond to the affine space. The geographic string encodings described here are simply string representations of hierarchical coordinates. The described embodiment teaches unique uses of these strings in geographic text retrieval that ca be applied to strings from any hierarchical coordinate system or any other coordinate system converted to a hierarchical string.

In one embodiment, geoparser 104 inserts this geographic text string directly into the document next to the geospatial reference. This approach is referred to herein as the “inline” method. According to the inline method, geoparser 104 actually modifies the document, which results in altering the positions of all words within the document that follow the location at which the special text string is inserted. In other words, the inline method “warps” the document and this will likely affect the search results when proximity conditions are used in a search query.

An alternative approach that avoids this problem is referred to as the “standoff” method. According the standoff method, a separate file is created that carries the special text strings. Besides carrying the text string, the separate file also specifies the character positions identifying the locations of the corresponding geospatial references within the actual document. This allows the geographic text strings to be associated with one character position, a character range, one word position, or a chosen set of words in the document. By choosing the words that identify the geographic reference, the standoff method does not warp the document and permits the geographic text strings to participate in relevance ranking computations that use textual proximity. Generic search engines typically do not support standoff metadata. An enhanced search engine may handle standoff metadata.

Geoparser 104 stores the encoded geographic metadata information in temporary document repository 102 as part of the documents either as inline or standoff metadata. Adding these special strings to copies of the documents essentially tricks traditional text indexing software into interpreting these special strings as regular words thereby making them searchable by conventional text search software using generic query styles. This, in turn, enables a conventional text search engine to easily locate all documents that contain geographic representations that are relevant to geographic ranges specified by the map user interface.

Typically, although not always, multiple documents are stored in document repository 101 and can be bulk processed in batches to create temporary document repository 102 in which the metadata is added. Alternatively, individual documents can be geoparsed as part of a larger processing system, such as a document tagging pipeline or a document editor user interface that allows a user to check the accuracy of the metadata output by the geoparser.

Documents stored in repository 102 typically have document identifiers, such as URLs, that allow users to retrieve a document simply by entering the document identifier into a viewer, such as entering a URL into a web browser. Text indexing engine 106 processes documents from repository 102 to create an “inverted index” or text index 108 that can be operated by text search engine 110 to allow users to retrieve documents based on the keywords and/or the geospatial references contained in the document instead of requiring the user to know the document identifier.

Text index 108 is usually represented as large files stored on disks or in memory. Text index 108 allows users to retrieve documents or document references, such as URLs, based on search query commands input through a keyword search user interface 114. Keyword search user interface 114 allows users to construct queries that are used for searching the document in repository 102. The search query will typically include one or more strings of characters and possibly operators, such as quotation marks to denote sets of strings separated by spaces, asterisks to denote wildcard matching, and AND/OR/NOT operators to denote Boolean operations. Text search engine 110 then applies these commands to the information that it has stored in text index 108 about the documents in temporary document repository 102. The information in text index 108 is typically organized by the text indexing engine that created the index to optimize the time required to apply these commands. For example, to enable fast retrieval of words that begin with the letters “cat,” text index engine 110 might create and store a list of all document identifiers to documents that contain any word beginning with “cat,” including documents that contain the word “catalog” and “catastrophe.” This allows the text index to answer a wildcard query of the form “cat*” simply by returning that list of document identifiers, which is much faster than reprocessing every document in search of words that match that query command.

In the described embodiment, map user interface 116 enables the user to define through a graphical user interface the geographic regions that are to be included as search criteria. It is referred to as an “enhanced” map user interface because it not only specifies the geospatial ranges that are input by the user through a graphical user interface but it also converts those geospatial ranges into geographic string encodings such as are described below in greater detail. These are supplied to text search engine 114 which uses them to search text index 108 to identify the relevant documents in temporary document repository 102.

Map user interface 116 interacts with text search engine 110 via keyword search user interface 114, which is a generic keyword search user interface that is able to interact with text search engine 110. Keyword search user interface is the interface into which the user types the keywords that will make up part of the overall search query that is to be applied by text search engine 110. An alternative approach would be to design map user interface 116 to interact directly with the text search engine 110, in which case it might incorporate the functionality of a keyword search user interface thereby allowing the user to enter keywords or search commands that are passed to the text index software along with the encoded geographic queries.

Map user interface 116 can be implemented by any one of a large number of map viewing applications, including, for example, an ESRI ArcGIS client running on a desktop computer that employs the Windows operating system or a web-browser-based application served by a web server that has been enhanced with the ability to issue queries to a text search engine using the encodings described below. The results from text search engine 110 are typically plotted on the map in the viewing application.

Map search user interface 116 allows a user to select a spatial domain of interest by zooming a map image. The viewable map area within the image can then be used as the query constraint, or the user may be allowed to define the spatial search criteria by highlighting areas of interest on the map. A two-dimensional map search user interface, for example, might show a latitude-longitude map of a region like Europe and allow a user to draw a loop around their area of interest. On the other hand, a three-dimensional map search user interface might show a fly through of a building complex and allow a user to select a parallelepiped surrounding a hallway of interest. There are numerous known techniques for using such a graphical user interface to define simple or complex regions of interest. In any event, the multi-dimensional domains of interest are then combined with keyword search commands and sent to generic text search engine 110 which uses only generic query styles to represent both the geographic and non-geographic query constraints. This retrieves documents or document identifiers that match both the spatial domain and keyword constraints.

Note that the above-described interleaved representations that are stored in the documents and that are indexed in the text index enable text search engine 110 to easily perform range searches using generic query styles. For example, a wildcard search for 4284* when applied to the a text search index will retrieve all documents with coordinates between “42840000” and “42849999.” Stated differently, that wildcard search will retrieve all documents with coordinates that fall within the entire rectangular region bounded by (48.00°, 24.00°) and (48.99°, 24.99°). This is described in further detail below.

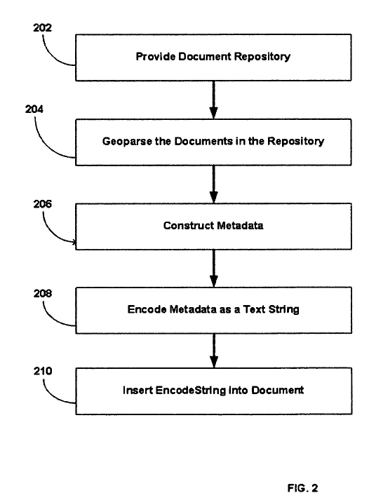

FIG. 2 shows a flow diagram of the process by which the system builds the text indexes that include the geographic text strings. Initially, the operator or system administrator provides a repository of all documents that are to be searchable (step 202). Then, the geoparser goes through each document in the repository to identify geospatial references (step 204). For each geospatial reference that is identified in a document, the geoparser determines the geographical locations to which that geospatial reference might refer; it computes a confidence score for those locations; and it constructs metadata containing that information (step 206). The geoparser then encodes the metadata into a geographic text string of the type described above (step 208), and it inserts those into the document using either the inline approach or the standoff approach (step 210). After the geoparser processes all documents in the document repository in that way, the resulting augmented document repository is ready to be indexed by the text indexing engine.

Alternatively, the system might apply the geoparser to the documents as they are passed through a processing pipeline between the repository and the indexing engine. The metadata need not be stored in the repository. The metadata can be associated with the documents in-memory as they are passed into the indexing engine.

The text indexing engine indexes the documents in the repository using techniques that are commonly employed by such engines (step 210). However, because the geospatial information has been added to the documents as special text strings, the text indexing engine will index that information in the same way that it indexes all keywords and keyword phrases that are found within the corpus of documents. The resulting inverted index, which may include many indices each one for a different keyword or keyword phrase, maps all keywords and text strings to the appropriate documents in the document repository.

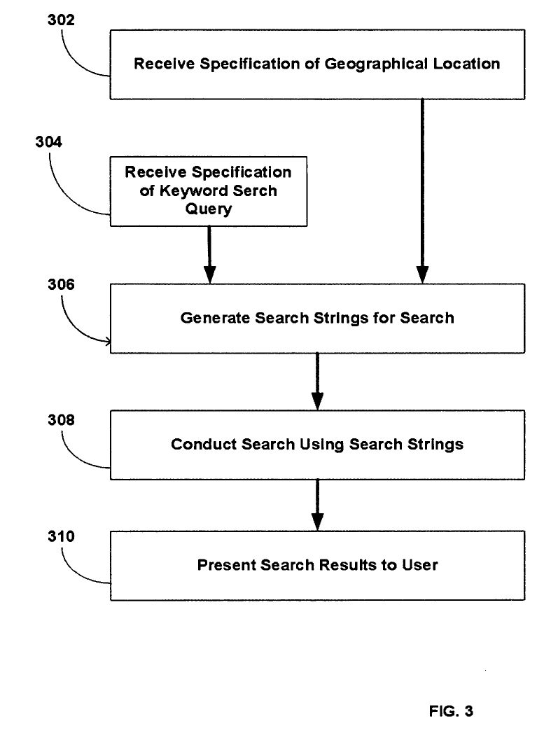

FIG. 3 shows how the system enables a user to search for all documents that are relevant to a query that includes one or more keywords and a geographical region of interest. The map user interface presents the user with a visual graphical representation that enables the user to specify the geographical region or regions that are to part of the search query (step 302). Through this interface the user identifies all geographical regions for which the user wants to see documents that contain geospatial references that are relevant to those geographical regions. The user is also permitted by the interface to specify a confidence threshold which instructs the search engine to ignore any documents that contain geospatial references for which the probability that it is referring to the specified geographic is not sufficiently high.

Another part of the interface, namely the keyword search user interface, enables the user to also specify a list of keywords that are to form part of the search query. The interface also enables the user to use conventional Boolean and other standard operators and conditions to construct the keyword search query (step 304). For example, keyword1 w/in 3 of keyword2 might be written as

“keyword1 keyword2” ˜3

where the ˜3 at the end denotes the permissible word separation between the words in quotes.

The user interface then generates the appropriate search strings that are to be presented to the text search engine to define the search criteria that are to be applied to the search (step 306). As part of this operation, it encodes the selected geographical regions into the special strings of the type that are described elsewhere in this document.

After the search query has been formatted into whatever format is required by the search engine, the system presents the search commands to the search engine, which then conducts the search (step 308). After completing the search, the search engine presents the results to the user in some useful form, e.g. as information displayed in visual display or printed out in hard copy or stored on electronic media (step 310).

Constructing Hierarchical Coordinates from Affine Space n-Tuples

In the described embodiment, the geographic coordinate metadata created by the geoparser is converted to hierarchical coordinates by interleaving, as described in this section. This interleaving can be performed on any multi-dimensional affine coordinate tuple, such as those on the sphere of the Earth or in Euclidean three-dimensional space. The tuple could include latitude, longitude, and meters above sea level, or x-feet east and y-feet north of a particular anchor point. Interleaving takes the first digit of each coordinate and concatenates them, and then the second digit from each coordinate and concatenates them to the string of first digits, and so on through all the digits. For example, the coordinate location 432 feet east and 987 feet north can encoded as:

493827

This requires the reader of such a string to understand the number of dimensions (two in this example) and the order of concatenation. In this example, the order of concatenation is east first and then north second. This string encoding is equivalent to a hierarchy of squares. The number 49 corresponds to a square that includes all coordinates between 400.000 . . . and 499.999 . . . feet east and 900.000 . . . and 999.999 . . . feet north. As this last sentence illustrates, the normal assumption about precision is forced to change when thinking about hierarchical coordinates built from string interleaving. The precision is determined by the length of the string, and it is no longer correct to automatically assume an infinite string of zeros at the end of the hierarchical coordinate. A hierarchical coordinate refers to an area. In this example, each coordinate refers to a square. The longer the string, the smaller the square.

For another example using more dimensions, consider the location −32.21° latitude, −78.19° longitude, and 4349 meters above sea level. This can be encoded as the following string:

−3-74283214199.

However, to avoid the use of negative numbers, the geoparser might encode these coordinates by first shifting the origin so that negative symbols do not appear. To keep the number of left-of-decimal-point digits the same amongst all the coordinates, the geoparser adds padding zeroes. So, for the location mentioned above, the geoparser could shift the origin 90° south and 180° west and pads with zeros to produce the following interleaving encoding:

(00057.79°, 00101.81°, 04349.00)=000004013504719780910.

This string encoding is equivalent to a hierarchy of rectangular areas.

The n-tuple interleaving described here preserves the singularities of the original coordinate system. For example, latitude-longitude coordinates behave poorly at the poles, by having many very different coordinates for nearly the same location. A hierarchical coordinate system constructed directly from latitude-longitude by interleaving still contains this problem, by having squares of equal “size” cover very different amounts of real ground when considered at the poles versus at the equator.

In the examples of query styles below, we will use this example string:

(057.79°, 101.81°)=0150717891

Other hierarchical coordinate systems, such as QTM avoid this problem by more clever construction. All hierarchical coordinate strings are amenable to the formatting techniques described in this document.

Range Constraints Implemented via the Trailing Wildcard Generic Query Style

A document containing hierarchical string used in the example above can be found using a trailing wild card query such as 000004013504* since this query would retrieve any string between 000004013504000000000 and 000004013504999999999. This range of text strings corresponds to the encodings for all locations within the three-dimensional bounding box ranging from (00050.00°, 00100.00°, 04340.00) to (00059.99°, 00109.99°, 04349.99).

The right-most digits in these strings are the least significant. For an n-dimensional affine space coordinate, the last n-digits correspond to the least significant digit in each of the coordinate directions. It is typical to assume infinite precision on these coordinates, which implies an infinite string of zeros appended to the right of these least significant digits. For a range constraint, implemented via the wildcard generic query style embodiment described here and the other embodiments described below, the documents retrieved by the range query will include all those with matching prefix string (most significant digits) regardless of the precision (i.e. length of non-zero string).

The trailing wildcard query style can be combined with non-geographic query constraints. For example, to find documents that refer both to the word “roadblock” and a location within the bounding box with latitude greater than or equal to 50 degrees and less than 60 degrees, and longitude greater than 100 and less than 110 degrees, a query like one of following might be sent to the text search index:

roadblock 0150*

“roadblock 0150*” ˜40

roadblock magicstring0150*

The first example requires that the document contain the word roadblock and also contain the exact phrase following the magic string. The second example requires that document contain roadblock be within 40 words of the magicstring phrase. The third example shows how a special identifying string, such as the characters “magicstring,” might be attached to the beginning of the specially encoded geographic string in order to ensure that the wild card search only acts on those numbers that were inserted by the geoparser and not other extraneous numbers occurring in the documents.

Range Constraints Implemented by the String Matching Generic Query Style

Some search engines perform slowly on wildcard queries. An alternative to the above design involves inserting all possible prefix strings into the engine. For the example string described above (057.79°, 101.81°)=0150717891, the system could insert all prefixes contained in this string:

0

01

015

0150

01507

015071

0150717

01507178

015071789

0150717891

This causes the text-indexing engine to store every prefix as a word in the document. A query for any of the prefixes then retrieves the documents. As in the example above, each prefix might be prepended with a magicstring to ensure that it is uniquely identifiable via the query. If the indexing engine supports the standoff method, then all the prefixes can be associated only with the character or word positions of the geographic reference. While this design may require the text index to hold many more words, the words can be stored in a simple index that need not support wildcard queries. As with the wildcard query style, this string matching query style can be combined with non-geographic query constraints. For example, to find roadblocks within a particular area, one need only issue a query for:

roadblock 0150

As above, the proximity operator could be used to find roadblock within a certain number of words of the spatial reference. This illustrates a problem with the proposed technique. If the specially formatted hierarchical strings are inserted inline, then the word proximity operator might count them as part of the separation between query words. This is not the most correct behavior. By accepting standoff metadata, an enhanced search engine avoids this problem. Standoff metadata allows multiple of the specially encoded geographic strings to occupy the same word position as already existing words in the document.

Range Constraints Implemented via Phrase Search Generic Query Style

Typical generic text search engines are equipped with the ability to search for a phrase. Depending on the design of the engine, a phrase search can be more efficient than a trailing wild card search because the system does not have to generate a list of all the sub-words beginning with the search string that precedes the wild card. Another cause of inefficiency in wildcard searches comes from the use of separate indices: if the prefix index does not include character positions, then searches on the prefix index must be joined with a word position index in order to compute textual proximity based word relevance functions. In this method, the system needs only to search for word combinations using the phrase search generic query styles.

To enable phrase search queries the hierarchical strings are broken into separate strings (or phrases) by white spaces. For example, the above examples could be rewritten:

000004013504719780910→000 004 013 504 719 780 910

0150717891→01 50 7178 91

Phrase searching can treat the sought for elements of the text string as separate words, and search only for the required word combinations.

To ensure that the query matches only intended strings, a special string is added to the beginning of the encoding. For example, in the described embodiment, the following string is added to a document:

magicstring01 50 71 78 91

In this case, a phrase search for

“magicstring01 50 71 78 91”

retrieves documents within the same bounding box as the previous example. This phrase query can be combined with non-geographic query constraints. For example, to find documents that refer both to the word “roadblock” and a location within the bounding box used in the above example, either of these queries might be sent to the text search index:

roadblock “magicstring01 50 71 78 91”

“roadblock “magicstring01 50 71 78 91””˜40

The first example requires that the document contain the word roadblock and also contain the exact phrase following the magic string. The second example requires that document contain roadblock be within 40 words of the magicstring phrase.

The phrases can be any size. However, there might be an advantage to selecting a size that corresponds to the number of dimensions of the coordinate space. In the above example, the coordinate space had two dimensions, namely, latitude and longitude; and the phrase that was selected had two digits. Thus, by adding another set of three characters to the trailing end of the phrase search specified above, one reduces the size of the query box by a factor of ten along each dimension.

Other generic query styles may also operate effectively on hierarchical strings when formatted correctly before insertion into documents indexed by a generic search engine. The invention includes any use of generic query styles to access specially formatted hierarchical strings added to unstructured documents.

Encoding Confidence Levels

The geoparser can also add natural language confidence scores about the geographic metadata to the specially formatted hierarchical strings simply by treating confidence as another coordinate dimension. To extend the previous example, assume that it now includes a confidence score:

| latitude | longitude | altitude | confidence of 88% |
|---|---|---|---|
| (00057.79°, | 00101.81°, | 04349.00, | 00088.00) |

The geoparser could encode the confidence as though it were a fourth affine coordinate dimension. For trailing wild card queries, this would look like this:

magicstring0000004001305048719878009100

Or for phrase search queries, treating the confidence as a new coordinate would look like this:

magicstring0000 0040 0130 5048 7198 7800 9100.

The wild card query magicstring0000004001305048* retrieves documents referring to the latitude, longitude, altitude bounding box ranging from (50.00°, 100.00°, 4340 m) to (59.99°, 109.99°, 4349 m) with a confidence level between 80.00% and 89.99%. And in case of phrase searching, the phrase search string “magicstring0000 0040 0130 5048” retrieves the same set of documents.

An alternative to this approach is described below. Instead of treating the confidence as a fourth affine coordinate, it can be binned.

Normalizing the Coordinates Before Interleaving

In the encoding schemes presented thus far, the queries are forced to use the same degree of precision along all coordinate directions. If the coordinates have different numbers of significant digits, a query may specify a relatively small range in one dimension and a relatively large range in another dimension. Normalizing all the coordinate dimensions to a range between 0 and 1 mitigates this problem. Using the above example, the following normalizations are applied. The latitude is divided by 180, which is the largest deviation it can experience. The longitude is divided by 360, which is the largest deviation it can experience. And the altitude is normalized to 50,000 meters above sea level, which is an arbitrary maximum altitude. Since the confidence score is already normalized to one, it usually need not be changed. The resulting normalized coordinates would be:

| Original | Normalized |
|---|---|
| 57.79 | 0.321056 |
| 101.81 | 0.282806 |
| 4349 | 0.086980 |
| 88 | 0.880000 |

Using the interleaving procedure described above, the normalized coordinates encode as:

320828881260089050806600, for trailing wild car searches, and

3208 2888 1260 0890 5080 6600, for phrase searching.

Binning Coordinates Scores

To enable queries that use very different degrees of precision on the different coordinates, the geoparser can use a mixed encoding strategy in which the encoding scheme bins one or more of the coordinates and represents the binned coordinates in a way that excludes them from the interleaved coordinate encoding. For example, for binned confidence scores, the following bins can be defined:

| Bin | Bin Definition |
|---|---|
| A | above 80% |
| B | 50-80% |
| C | 20-50% |
| D | 0-20% |

An encoding which employs the binning would be as follows:

magicstring[bin number] [coordinate encoding].

Under this scheme, the previous example becomes:

| latitude | longitude | altitude | confidence of 88% |
|---|---|---|---|
| (00057.79°, | 00101.81°, | 04349.00, | bin A) |

and the encoding produces the following text string:

magicstringA000004013504719780910,

which can be searched with trailing wild card queries. Or, it produces the following phrase string:

magicstringA000 004 013 504 719 780 910,

which is amenable to phrase search queries. Or, it produces the following prefixes that can be searched without requiring wildcards nor phrase searches:

magicstringA0

magicstringA00

magicstringA000

magicstringA0000

magicstringA00000

magicstringA000004

magicstringA0000040

magicstringA00000401

( . . . all intermediate prefixes . . . )

magicstringA000004013504719780

magicstringA0000040135047197809

magicstringA00000401350471978091

magicstringA000004013504719780910

This encoding scheme, and its equivalents, enable a user who is interacting with an enhanced map search user interface to retrieve documents with a confidence score above 80% within a particular range simply by generating a keyword query for:

magicstringA000004013504*

for trailing wild card query-capable text search engines, or

“magicstringA000 004 013 504”

for phrase search query-capable text search engines, or any of the listed prefixes for an engine that does not necessarily support either phrase searches or wildcard searches.

Encoding for Various Grid Coordinate Systems

The interleaving scheme described above can be applied to coordinates from any affine space. Geographic mapping projections are examples of affine space coordinates. They often use sphere-like coordinates on the globe. Common examples include “unprojected” latitude-longitude and Universal Transverse Mercator (UTM).

Grid coordinate systems also known as “hierarchical” coordinate systems, such as military grid reference system (MGRS) and the quaternary triangular mesh (QTM), are already in a hierarchical representation. Such grid coordinate systems do not need to be interleaved. One can directly apply the special string formatting described above for each of the various generic query styles.

For example, QTM embeds an octahedron in the earth and then subdivides its triangular faces into four triangles, which are further subdivided into four triangles ad infinitum. Each face of the octahedron is numbered 0 to 7, and each triangular subdivision is numbered 0 to 3. The vertices of the polyhedron are then projected to the surface along radial lines of the sphere. Any point on the surface can now be specified to any level of precision with a longer or shorter string of digits, where the first ranges from 0 to 7, and each subsequent symbol ranges from 0 to 3. A trailing wild card query retrieves all locations within the last triangle number specified in the query.

The grid string can be formatted for the various types of generic query styles. For example,

| | |
|---|---|
| Original: | 2012030210230203012 |
| For trailing wild card queries: | 20120302* |
| For phrase searches: | 2012 0302 1023 0203 012 |
| For string matching: | 2 |
| | 20 |
| | (all intermediate prefixes) |
| | 201203021023020301 |
| | 2012030210230203012 |

When the confidence binning encoding scheme described above is used, the following types of strings are added as geographical metadata to the document to support corresponding queries that use trailing wild card searches and phrase searches:

| | Query for retrieving |
|---|---|
| | documents with a range |
| String(s) added to document | around this location |
| magicstringA2012030210230203012 | magicstringA20120302* |
| magicstringA2012 0302 1023 0203 012 | “magicstringA2012 0302” |
| magicstringA2 | Any of the prefix |
| magicstringA20 | strings displayed to |
| ( . . . all intermediate prefixes string . . . ) | the left. |
| magicstringA201203021023020301 | |
| magicstringA2012030210230203012 | |

Encoding Additional Information for Post-Query Processing

Most text search engines provide results with snippets of text containing instances of the search words from the original documents. To provide more useful results to the user, the geoparser adds extra information to the existing encodings by appending one or more letter/number pairs to the encoded string. When it presents the search results, the search engine retrieves this information to help the user locate within the text of the document the geotags of interest. For example, in order to indicate that the words used to make a particular geotag started 12 characters preceding the first character in this geotag, the letter/number pair “c12” is added, as follows:

magicstringA2012 0302 1023 0203 012c12.

To indicate that a normalized representation of the interpreted string is presented in the 15 characters following this geotag, the scheme adds a second letter/number pair as follows:

magicstringA2012 0302 1023 0203 012c12b15

The addition of such information to the geographical metadata information allows the application that presents search results to the user to do so in a way that is more intelligible to the user. For example, the system can highlight the geotags in one color and their normalized representations in another color.

Multiple Queries from a Mapping Application

For queries having a geographical range with boundaries that do not fall along normal boundaries within the selected coordinate system, the map user interface constructs the desired query from multiple sub-queries. According to one approach, the mapping application takes a domain specified by user input and converts it to a set of multiple queries that use generic query styles, such as trailing wildcards or phrases. The mapping application then combines these multiple queries with Boolean OR operators to form a single query expression. Alternatively, the mapping application sends multiple queries to the text search engine. In the latter case, the mapping application may have to combine several result lists that are returned by the search engine and it may have to trim results that fall outside the range intended by the user's input. Trimming is done by searching through the returned documents and identifying those for which the geospatial references fall outside of the user's specified range. But since the set of returned documents is usually small in number in comparison to the number stored in the repository, the trimming operation is typically not that time consuming.

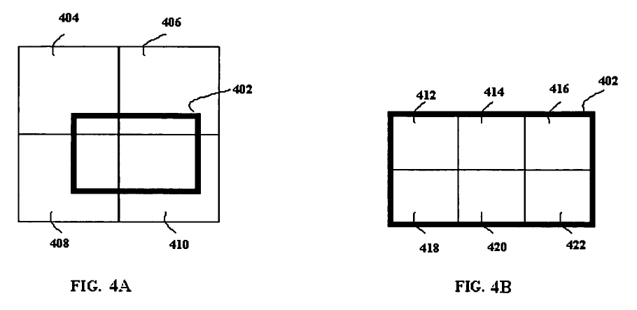

An example of multiple queries is illustrated in FIG. 4A in which the bold lined box 302 indicates the rectangular range queried by a user. According to the method shown in FIG. 4A the mapping application merges four sub-queries, indicated by boxes 304, 306, 308, and 310, and then trims results that fall outside the bold box. Alternatively, the mapping application generates a single four-part OR query for results falling in boxes 304, 306, 308, or 310, and then trims the results.

According to the method shown in FIG. 4B, the mapping application merges six sub-queries indicated by boxes 312, 314, 316, 318, 320, and 322, or alternatively generates a single six-part Boolean OR query. This method requires no trimming; however, it requires that the boxes be defined so that their boundaries fall on the boundary of the bold box. Meeting the second condition might require using a box size that is so small that the number of searches that need to be performed by the search engine seriously deteriorates the efficiency of the procedure.

The enhanced map search user interface might query multiple search engines. Since the different search engines might handle different generic query styles more or less efficiently, they can be “wrapped” in different embodiments of this invention. One might be setup to use trailing wildcard generic query styles to implement range queries, and another might be setup to use phrase search generic query styles. When the client receives results from the various search engines, it can merge the results into one or more result sets to present to the user.

Enhanced Search Engines

In addition to the standoff metadata enhancement described above, three other enhancements are disclosed. These improve the relevance sorting function that allows the search engine to present the most pertinent results first. These three enhancements deal with:
1. Confidence of the correctness of the coordinates
2. Relative term position of both geographic and non-geographic terms
3. Word usage frequencies

As described elsewhere in this document, confidence scores are typically generated by the geoparser to indicate the likelihood that a particular coordinate was intended by the author of the document. The most powerful way to incorporate confidence scores into a search engine is to enhance the index so that each word carries with it a general confidence value. Such a general confidence value can be assigned to any type of word, geographic or non-geographic, and can be used to indicate the likelihood that the author intended for that word to be in the document. Obviously, most of the words were written by the author, so most of them have 100% confidence. However, as metadata is added to the document by various automated processes, some of the text may have less than 100% confidence. If a search engine supports this notion of confidence, then a scoring function operating on a result list can utilize this per-term confidence information directly as a generic feature in the search engine. If a search engine does not support this notion of confidence, then it can be incorporated into the specially formatted hierarchical strings using either the confidence binning method or by treating it as an additional affine coordinate, as described above. Either of these methods require the enhanced map search interface to formulate queries for ranges or bins of confidence, and thus to enforce the impact of confidence on the relevance from outside the search engine. The client issuing the queries does this by using a generic query style to first request documents within a high confidence range or bin, e.g., greater than 80% confidence, and then if not enough results are returned, the client can request additional documents in a lower range or bin. An enhanced search engine can incorporate confidence values directly into its relevance computation in a variety of ways, including simply multiplying the documents relevance by the highest confidence that matches the constraint.

The relative term position of both geographic and non-geographic terms is crucial to most unstructured information retrieval relevance functions. Part of the utility of the specially formatted geographic string encodings taught by the described embodiment, is that they take direct advantage of existing term-proximity infrastructure in the generic search engine. As described above, there are two methods of adding the specially formatted strings to the documents indexed by the search engine: inline and standoff. The inline method is easiest to implement, because it modifies the document without complicating its structure. The standoff method requires the search engine to support the notion of having multiple words occupying the same word position in the document. This is a standard concept in many document authoring systems. For example, Microsoft Word allows comments and edit marks to refer to various word positions in the document. These additional pieces of information are not part of the body of the document, yet they are associated with specific parts of the body. For search engines that support standoff metadata, the specially formatted geographic strings are particularly effective, because they become part of the document without warping the length of document. Regardless of which method is used, both methods associate the specially formatted geographic strings with specific regions of text in the document. The geographic strings are given word positions in the text. This means that they are automatically and seamlessly incorporated into any word-proximity calculation performed by the search engine's generic relevance calculation. Even with the warping of the inline insertion method, this provides dramatically better results than attempting to merge results from two separate indices.

The third enhancement contemplated relates to term frequencies. Typically, relevance functions use the frequency of a term to determine its importance. Intuitively, one expects that rare words are more important than common words included in a user's search. The frequencies of occurrence are calculated by dividing the number of occurrences of the word to the total number of words. Thus, the term-document frequency (TDF) and the term-corpus frequency (TCF) of a given word are:

$$TDF ( word ) = \frac{number of occurrences ( word ) in the document}{total number of words in document}$$

$$TCF ( word ) = \frac{\begin{matrix}number of occurrences ( word ) \\ in the collection of documents\end{matrix}}{total number of words in the entire collection}$$

Relevance calculations typically include various functions involving logarithms and other mathematical curves applied to the ratio of these two frequencies. If the total number of words in the collection or in a document includes all the specially formatted hierarchical strings, then the relevance function might be warped by their presence. This can be avoided by constructing a relevance function that ignores the magicstring words in its counting of word occurrences.

Other enhancements to a search engine may facilitate the use of these specially formatted hierarchical strings. For example, word emphasis and other statistics might be added to the strings or the handling of the strings. Embodiments include all such enhanced search engines that use generic query styles to access the specially formatted hierarchical strings.

Other embodiments are within the scope of the following claims. For example, the text string encoding of the spatial coordinate systems can be interleaved in different orders, such as by taking a digit of the longitude before the corresponding digit of latitude, or by taking the altitude digit first. In addition, confidence information can be combined with the spatial coordinate-derived text string according to other encoding schemes, as long as a key word query can be formulated for the desired searches. Geospatial ranges can be two-dimensional, three-dimensional, or n-dimensional, each with regular or arbitrarily defined boundaries. The ranges can be measured in familiar “absolute” coordinates, such as latitude and longitude, or in relative coordinates, such as coordinates with respect to an arbitrary point. Any desired coordinate normalization scheme can be used that offers users the ability to specify geospatial ranges of interest. Such ranges can include similar absolute ranges in each of several dimensions, or disparate ranges in one or more of the dimensions. The geographic string formats can be applied to any hierarchical coordinate system or hierarchical representation of any affine space.

1. A method of processing a document, the method comprising:
identifying a plurality of one or more geospatial references within the document; and for each identified geospatial reference of the plurality of geospatial references:
associating a geographical location with the identified geospatial reference, the geographical location being represented by a set of coordinates of a selected coordinate system;
generating a hierarchical coordinate representation of the set of coordinates;
generating a geographic text string based on the hierarchical coordinate representation, wherein the geographic text string can be retrieved by a query posed in a generic query style; and
associating the geographic text string with the identified geospatial reference.

2. The method of claim 1, wherein the generic query style is a trailing wildcard query.

3. The method of claim 1, wherein the generic query style is a phrase search query.

4. The method of claim 1, wherein the generic query style is a string match query

5. The method of claim 1, wherein the selected coordinate system is non-hierarchical, and generating a hierarchical coordinate representation involves interleaving the coordinates of the set of coordinates.

6. The method of claim 5, wherein the selected coordinate system comprises latitude and longitude coordinates.

7. The method of claim 1, wherein the selected coordinate system is a quarternary triangular mesh, coordinate system.

8. The method of claim 1, wherein associating the geographic text string with the identified geospatial reference comprises inserting that geographic text string into the document at the location of the corresponding geospatial reference.

9. The method of claim 1, wherein associating the geographic text string with the identified geospatial reference comprises placing that geographic text string into a standoff metadata data structure that identifies the geospatial reference with which that geographical text string is associated in the document.

10. The method of claim 1, wherein for each identified geospatial reference of the plurality of geospatial references also determining a confidence level for the associated geographical location and wherein encoding the geographical location as a geographic text string involves encoding both the geographical location and the confidence level into the geographic text string.

11. The method of claim 10, wherein generating the geographic text string involves representing the confidence level within the text string as a corresponding bin of a plurality of bins, each of said plurality of bins representing a different range of confidence levels.

12. The method of claim 1, wherein generating the geographic text string involves adding a sequence of characters that identify a portion of text in the vicinity of the geospatial reference.

13. A method of processing a document, said method comprising:
identifying a plurality of one or more geospatial references within the document; and
for each identified geospatial reference of the plurality of geospatial references:
associating a geographical location with that identified geospatial reference, said geographical location being represented by a set of coordinates of a selected coordinate system;
determining a confidence level for that associated geographical location;
encoding both the geographical location and the confidence level for that identified geospatial reference as a geographic text string; and
associating the geographic text string with the identified geospatial reference.

14. The method of claim 13, wherein encoding involves interleaving the coordinates of the set of coordinates for that associated geographical location to generate the geographic text string.

15. The method of claim 13, wherein encoding both the geographical location and the confidence level for that identified geospatial reference as a geographic text string involves representing the confidence level within the text string as a corresponding bin of a plurality of bins, each of said plurality of bins representing a different range of confidence levels.

16. The method of claim 13, wherein encoding both the geographical location and the confidence level for that identified geospatial reference as a geographic text string involves representing the confidence level as a number string and interleaving the number string along with the coordinates of the set of coordinates for that associated geographical location to generate the geographic text string.

17. The method of claim 13, wherein the selected coordinate system is a hierarchical coordinate system.

18. The method of claim 13, wherein the selected coordinate system comprises latitude and longitude coordinates.

19. The method of claim 13, wherein the selected coordinate system is a quarternary triangular mesh, coordinate system.

20. The method of claim 13, wherein associating the geographical text string with the identified geospatial reference comprises inserting that geographical text string into the document at the location of the corresponding geospatial reference.

21. The method of claim 13, wherein associating the geographic text string with the identified geospatial reference comprises placing that geographic text string into a standoff metadata data structure that identifies the geospatial reference with which that geographical text string is associated in the document.

22. A method of processing a set of documents, the method comprising:
for each document in the set of documents,
identifying a plurality of one or more geospatial references within that document; and
for each identified geospatial reference of the plurality of geospatial references within that document:
associating a geographical location with the identified geospatial reference, said geographical location being represented by a set of coordinates of a selected coordinate system;
determining a confidence level for the associated geographical location;
encoding the geographical location and its confidence level into a geographic text string; and
associating the geographic text string with the identified geospatial reference.

23. The method of claim 22, further comprising creating a generic search engine text index for the set of documents, wherein the text index indexes both the words within the set of documents as well as the geographic text strings that are associated with the documents within the set of documents.

24. The method of claim 22, further comprising creating an enhanced search engine index for the set of documents, wherein the enhanced search engine index indexes both the words within the set of documents as well as the geographic text strings that are associated with the documents within the set of documents, the enhanced search engine index providing special handling for the geographic text strings.

25. The method of claim 24, wherein the special handling provided by the enhanced search engine index comprises allowing confidence values associated with the geographic text strings to impact a relevance scoring.

26. A method of constructing a text search query for identifying among a plurality of documents those documents that contain geospatial references that are associated with a geographic location, said method comprising:
receiving an identification of said geographical location;
in response to receiving said specification, representing said geographical location as a set of coordinates; and
generating a geographical text string from the set of geographical coordinates by interleaving the coordinates of the set of coordinates for said geographical location.

27. The method of claim 26, further comprising submitting the geographical text string to a text search engine which searches a text index to for the plurality documents to identify those documents that contain geospatial references that are associated with said geographic location.

28. The method of claim 26, further comprising receiving a specification of a confidence, wherein generating the geographical text string further involves combining a representation of the confidence level with the set of geographical coordinates to generate said geographic text string.

29. A method of utilizing multiple different search engines to construct geographically constrained searches, the method comprising:
generating a plurality of specially formatted hierarchical strings;
sending the plurality of specially formatted strings to a plurality of search engines, wherein each of the search engines has indexed documents augmented with at least one specially formatted hierarchical string; and
upon receiving responses from the plurality of search engines, generating one or more result layers.
